(19) United States
(12) Patent Application Publication
(10) Pub. No.: US 2008/0268808 A1
(43) Pub. Date: Oct. 30, 2008

(54) Mobile First Responder Tracking, Tagging, and Locating System

(76) Inventor: Anthony Gray, (US)

Correspondence Address: Anthony Gray, 2827 Bayshore Trails Drive, Tampa, FL, 33611, US

(21) Appl. No.: 11/741,759

(22) Filed: Apr. 29, 2007

(51) Int. Cl. H04M 11/04

(52) U.S. Cl. 455/404.2

(57) ABSTRACT

A software system used to track and locate mobile first responders such as law enforcement and firefighters. The system consists of software that loads on first responder cellular telephones and provides recurring position reports, personal emergency distress reports, and data files such as pictures, video, and audio that have been tagged with the cellular telephone's global positioning system (GPS) information. Information from the cellular telephone is sent to server software that represents the information on a map display viewed via the Internet. Users of the invention are able to communicate and collaborate with one another by selecting one or a group of users from the display and in turn sending text, email, and voice messages to one another.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Field of the Invention

The subject invention is generally related to mobile electronic communications and is specifically directed to a comprehensive mobile data communications solution particularly well suited for first responders such as law enforcement and firefighters.

2. Discussion of the Prior Art

First responders such a law enforcement, firefighters, and Emergency Medical Services (EMS) personnel conduct a substantial amount of their work activities away from their vehicles. However, the current technology for the tracking of first responders and geospatial tagging of their data is vehicle mounted, short range (line of site) wireless communication systems, or cellular telephones with many limitations. Mobile data terminals (MDT) are commonly used by first responders and these devices are permanently mounted in first responder vehicles. Some of these MDT provide line of site wireless data communications between the vehicle mounted MDT and a portable peripheral handheld device. For example, a wireless line of site bar code scanner can be used by law enforcement to scan vehicle identification number bar codes during traffic stops and that information is transmitted to the MDT located in their vehicle. MDT devices in the art, such as the MDT presented in U.S. Pat. No. 6,518,881, have the ability to provide Global Positioning System (GPS) location tracking information for the first responder's vehicle. Some MDT also have the ability to receive line of site tracking information for mobile first responders, however, these devices are limited by range from the vehicle. First responders are able to use MDT to access data on the Internet, send and receive text messages, send and receive email, and access first responder databases.

In addition to MDT, cellular telephones are also widely used by first responders. GPS enabled cellular phones now allow first responders to be tracked while they are away from their vehicles. Data communication enabled cellular phones also allow first responders the ability to transmit and receive data such as text messages, pictures, and email while they are mobile and away from their vehicles.

However, MDT and cellular phone technology in the art still do not provide many necessary functions. In 2005, the FBI Uniform Crime Reporting Program showed that 11.9% of police officers were assaulted. Many of these assaults occurred while the officer was away from their vehicle. Current MDT and cellular technology in the art do not allow officers who are away from their vehicle to rapidly and inconspicuously transmit their location when they are assaulted. In such situations, it would be desirable for an assaulted first responder to be able to easily and inconspicuously alert their headquarters and other nearby first responders of their emergency situation and their exact location. Furthermore, it would be desirable for management and responding units to be able to receive any data or evidence relevant to the emergency situation from the scene of the attack. For example, a police officer may be conducting a traffic stop and the officer uses their cellular telephone to photograph the suspect's vehicle, license plate, the suspect, and witnesses. When the officer asks the suspect for their license, vehicle registration, and proof of insurance, the suspect fires a weapon at the police officer and speeds away from the wounded officer and the crime scene. Unable to reach their vehicle and perhaps unable to speak coherently, with current technology in the art, the officer would be unable to effectively report their distress, their precise location, and information on the suspect and their vehicle. It would also be beneficial for the assaulted officer to be continually tracked once the initial emergency alert has been sent.

While some MDT provide a map with the location of other first responders, no technology allows a first responder to look at such a map and rapidly contact and communicate another unit or many units at once via email or text messages. It would be beneficial for first responders to be able to contact and communicate with other units inside and outside of their jurisdiction by looking at a map display of their first responder unit locations, selecting the units they would like to communicate with, and be able to provide information via text or email message to those units. For example, a train carrying toxic gas derails near an urban area spanning multiple jurisdictions. The local on scene commander needs to be able to rapidly notify first responders in the area to shut down roads, direct traffic, remove civilians from the area, provide medical response to the injured both within the location of the derailment and also downwind of the derailment site. It would be beneficial for the on scene commander to be able to look at a map display of the area, select the mobile EMS units in the area, and send those units specific text and email messages providing the location of the wounded. Such a capability reduces the amount of voice communications which, during such large scale events, become congested, confused, and oftentimes ineffective during crisis situations.

### SUMMARY OF THE INVENTION

The subject invention provides client software that loads on first responder cellular telephones and provides tracking, tagging, locating, and emergency distress notification for mobile first responders. The subject invention also consists of secure server software that provides first responders a map display showing the location of all first responders using the cellular telephone software. The server software also allows first responders to select and communicate with specific first responders they see on the map display. The server software also allows first responders to access data from other first responders using the cellular technology software. The users of the map display are able to collaborate with one or many other users via text, email, and voice messages. Users in a collaborative group are able to highlight, add files, and text on the map display in order to share ideas. When the distress function is activated on the client software, a message with GPS location of the user is sent to the server software that identifies the user in distress on the map display and also sends distress emails and text notification messages to all contacts pre-assigned by the user to receive distress notifications. The distress reporting continues automatically until the function is deactivated on the client or the server software. The server software is also able to present other sources of data such as traffic, weather, and satellite imagery on the map display and the information may be filtered for specific user information needs.

### BRIEF DESCRIPTION OF THE SEVERAL VIEWS OF THE DRAWING

FIG. 1 is a system design of the invention

FIG. 2 is a flowchart of the software processes

### DETAILED DESCRIPTION OF THE INVENTION

The invention consists of “client” software loaded on cellular telephones and “server” software loaded on Internet servers. The client software loads on commercial off the shelf (COTS) cellular phones that are GPS enabled and capable of data communications. The client software runs a program that processes the GPS location on the GPS enabled cellular telephone. The client software then transmits the GPS location data from the telephone to the server software. The server software receives the GPS location for the first responder's cellular telephone and plots that location on a map display. This map display is made available to users of the invention via an Internet connection. The map display shows the location of all first responders using the client software. Users of the map display are able to see the individual first responders, their name and contact information. The user is able to change the frequency of their location reporting and even turn off the location reporting function.

In the event a first responder is in distress, they can activate a sequence of keys on the keypad of the cellular telephone and this action transmits an emergency distress signal to the server software. The server software processes the emergency distress signal and shows the location of that first responder on the map display as being in distress and shows the location information of that first responder. Users of the invention are also able to pre-assign specific receivers of a distress message so that when a first responder activates the distress signal on their cellular phone, a text or email message is transmitted to their pre-assigned list of contacts. When the user activates the distress signal on their cellular telephone, the client software transmits the distress signal to the server software. The server software then identifies the list of pre-assigned contacts and transmits text and email notifications to those contacts. The contacts receive an email and text message indicating the name of the individual in distress and supporting geographic information that displays where the individual in distress is located. The client software continues to transmit the distress location on a recurring basis to the server software until the distress signal is deactivated.

The client software processes data from the handset such as pictures, video, and audio files. These files are tagged with GPS location information and sent to the server software. The server software presents the files on the map display and stores them for future access. Users of the invention are then able to view these pictures, video, and audio files by viewing them on the map display.

From the map display, one or many users may be selected to receive a text or email message. When selected, the server software allows the user to communicate a message via text or email to those selected individuals. A group of users may also use the map display to collaborate via text messaging, email, and voice communication. During these collaboration sessions, users may highlight specific areas of the map and type information on the map display for others in their collaboration session to see.

The map display is also capable of receiving and showing other types of external data such as weather, traffic, hospital status, and satellite imagery information. This information is represented in its entirety or in part depending on how the users wish to filter the information on the map display.

### BRIEF DESCRIPTION OF FIGURES

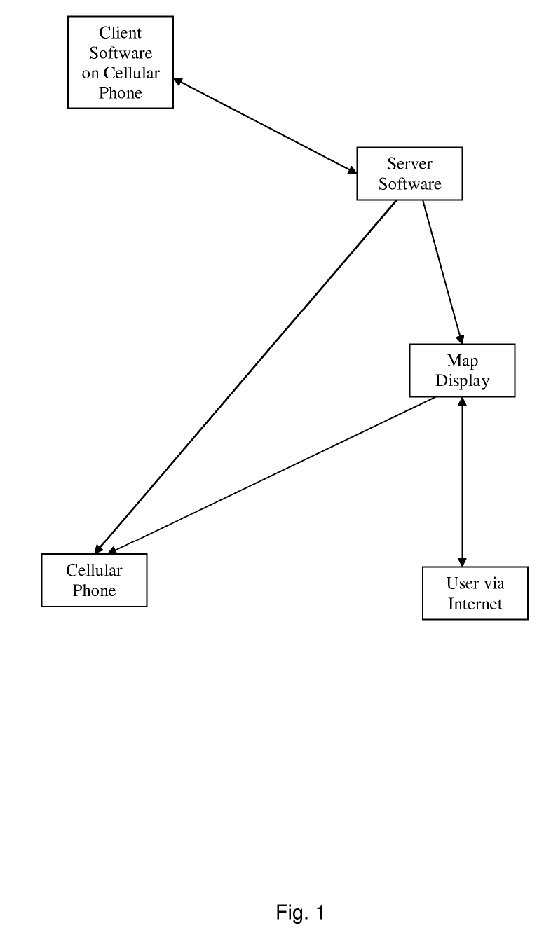

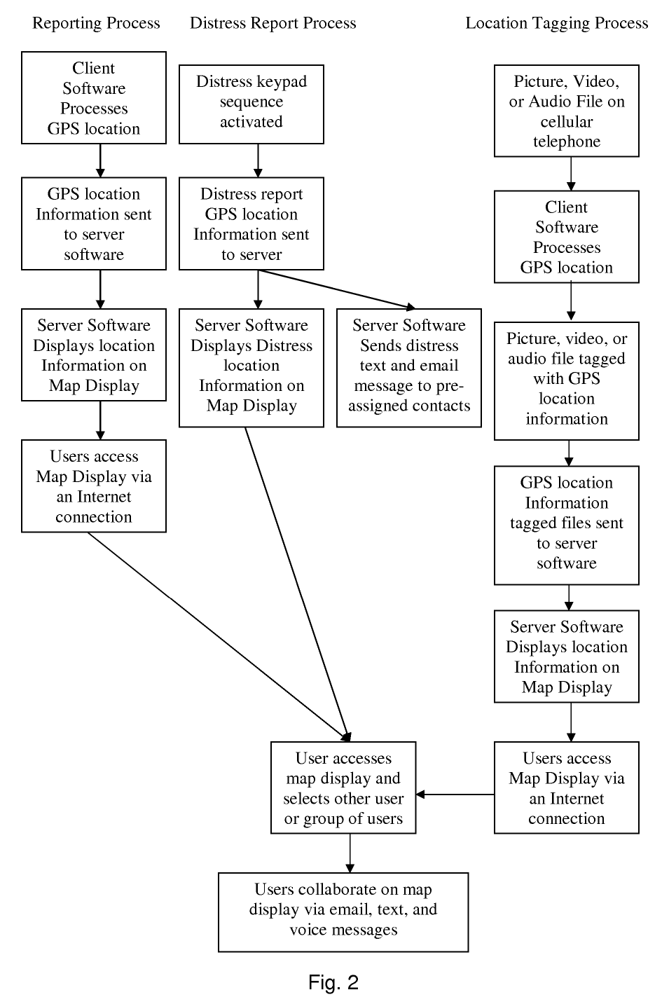

1.0 FIG. 1-2 represents the two way sharing of position location reports, distress location reports, as well as location tagged video, pictures, and audio file information between the Client Software loaded on the first responder cellular phone (top left box) to the Server Software. This figure then shows the flow of information from the Server Software to the Map Display that shows position location reports, distress location reports, as well as location tagged video, pictures, and audio files to User via Internet. The bottom right box represents other users able to receive position location reports, distress location reports, as well as location tagged video, pictures, and audio files on their Cellular Phones.

2.0 FIG. 2-2 shows how the Client and Server Software process position location reports, distress location reports, as well as location tagged video, pictures, and audio files.

What is claimed is:

1. A comprehensive mobile first responder tracking, tagging, and locating system consisting of client and server software providing position location reports, distress location reports, as well as location tagged video, pictures, and audio files, along with the ability to communicate and collaborate multiple data sources among users.

2. A system of claim 1, wherein client software is software that operates on a cellular or otherwise mobile telephone.

3. A system of claim 1, wherein server software is software that operates on an Internet server.
